(19) United States
(12) Patent Application Publication
(10) Pub. No.: US 2001/0019306 A1
(43) Pub. Date: Sep. 6, 2001

(54) Signal capture apparatus and imaging apparatus

(76) Inventor: Chikao Tezuka, Tokyo (JP)

Correspondence Address: MOONRAY KOJIMA, BOX 627, WILLIAMSTOWN, MA, 01267, US

(21) Appl. No.: 09/777,619

(22) Filed: Feb. 6, 2001

(30) Foreign Application Priority Data
Feb. 7, 2000 (JP) 2000-28559

(51) Int. Cl. G08B 23/00

(52) U.S. Cl. 340/573.1; 340/664

(57) ABSTRACT

The present invention provides a pressure sensor in the bore of a signal capturing means housing a subject to be imaged. The pressure applied by the subject to be imaged will be detected and displayed on the alerter unit to provide a signal capture apparatus and an imaging apparatus allowing the subject to have nothing in hand.

### BACKGROUND OF THE INVENTION

The present invention relates to a signal capture apparatus and imaging apparatus, and more particularly to a signal capture apparatus having space or storing subjects to be captured, and an imaging apparatus including such a capturing apparatus.

In an MRI (Magnetic Resonance Imaging) apparatus, a subject to be imaged will be carried into a space inside a magnet system, i.e., imaging space having static field formed. Then a gradient field and radio frequency field will be applied to generate magnetic resonance signals in the subject. The tomographic slices will be reconstructed (generated) from the signals received.

The subject housed in the imaging space may have a signaling means such as a switch in hand so as to send a signal to an attendant standing by, so that the signal based on the operation thereof will be displayed outside the imaging space.

There is a potential risk, in the method of signaling by the operation of an appliance that a subject holds in hand, that the subject is not able to signal when the subject drops the appliance.

### SUMMARY OF THE INVENTION

Therefore, it is an object of the present invention is to achieve a signal capture apparatus and imaging apparatus, having a signaling means allowing the subject to have nothing in hand.

(1) In an aspect for solving the problem above, the present invention is a signal capturing apparatus characterized by having a signal capturing means having a space for housing a subject to be detected, a pressure detector means provided in said spare for detecting pressures by said subject, and a display means for presenting the output signals from said pressure detector means.

In accordance with this aspect of the present invention, a pressure detector means for detecting pressures by the subject of signal capturing is provided in the space for housing the subject, the output signals therefrom will be displayed or alerted by means of a display means. The subject thereby will be allowed to have nothing in hand for the purpose of signaling.

(2) In another aspect for solving the problem above, the present invention is a signal capturing apparatus according to (1), characterized in that said pressure detector means uses air pressure.

In accordance with this aspect of the present invention, as the pressure detector means uses air pressure, no electro-magnetic interference signal will be generated.

(3) In still another aspect for solving the problem above, the present invention is an imaging apparatus characterized by having an imaging means having a space for housing a subject to be imaged, a pressure detector means provided in said space for detecting pressure by said subject, and a display means for presenting the output signals of said pressure detector means.

In accordance with this aspect of the present invention, a pressure detector means is provided for detecting pressures by a subject to be imaged in the space for housing the subject, and the output signals thereof will be displayed or alerted by a display means. The subject thereby will be allowed to have nothing in hand for the purpose of signaling.

(4) An still another aspect for solving the problem above, the present invention is an imaging apparatus according to (3), characterized in that said pressure detector means uses air pressure.

In accordance with this aspect of the present invention, as the pressure detector means uses air pressure, no electro-magnetic interference signal will be generated.

In accordance with the present invention, a signal capture apparatus and an imaging apparatus having a signaling means allowing the signal-sender to have nothing in hand may be achieved.

Further objects and advantages of the present invention will be apparent from the following description of the preferred embodiments of the invention as illustrated in the accompanying drawings.

### BRIEF DESCRIPTION OF THE DRAWINGS

FIG. 1 is a schematic block diagram of an exemplary apparatus of preferred embodiment in accordance with the present invention.

FIG. 2 is a schematic diagram of arrangement of a pressure sensor in the apparatus shown in FIG. 1.

FIG. 3 is a schematic block diagram of another exemplary apparatus of preferred embodiment in accordance with the present invention.

FIG. 4 is a schematic diagram of arrangement of a pressure sensor in the apparatus shown in FIG. 3.

FIG. 5 is a schematic chart illustrating an example pulse sequence executed by the apparatus shown in FIG. 1 or FIG. 3.

FIG. 6 is a schematic chart Illustrating another example pulse sequence executed by the apparatus shown in FIG. 1 or FIG. 3.

### DETAILED DESCRIPTION OF PREFERRED EMBODIMENTS

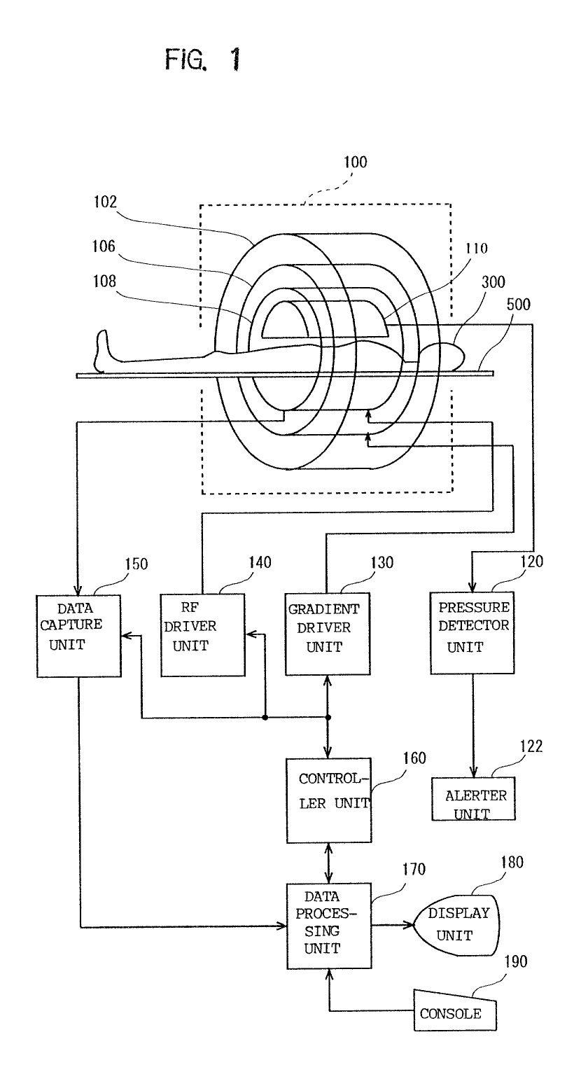

Some preferred embodiments of the present invention will be described in greater details herein below with reference to the accompanying drawings. FIG. 1 shows a schematic block diagram of a magnetic resonance imaging apparatus. This apparatus is an exemplary embodiment in accordance with the present invention. The arrangement of this apparatus indicates an example of preferred embodiments with respect to the apparatus in accordance with the present invention.

As shown in FIG. 1, the apparatus has a magnet system 100. The magnet system 100 includes a primary coil 102, a gradient coil 106, and an RF (radio frequency) coil 108. These coils may be broadly in the form of cylinders, installed coaxial to each other. A subject to be imaged 300, laid down on a cradle 500, will be carried in and out to the bore broadly in the form of cylinder of the magnet system 100, by means of a transporter means not shown in the figure.

The primary coil 102 may form a static field in the bore of the magnet system 100. The direction of the static field is in general in parallel to the body axis of the subject to be imaged 300. I.e., the coil forms a so-called horizontal magnetic field. The primary coil 102 may be constructed for example by using superconductive coils. The coil may also be constructed, needless to say, from ordinary conductive coils instead of superconductor.

The gradient coil 106 may generate a gradient magnetic field for making a gradient in the static magnetic field intensity. The gradient magnetic field thus generated will be of three types including slice gradient field, read out gradient field, and phase encode gradient field, in correspondence with which three types of fields, the gradient coil 106 has three gradient coils, not shown in the figure.

The RF coil 108 may form an RF magnetic field in the static magnetic field for exiting spins in the body of the subject to be imaged 300. The generation of high frequency magnetic field will be referred to as transmission of RF exciter signals, herein below. The RF coil 108 may also receive electromagnetic waves generated by the spins excited, i.e., magnetic resonance signals. The RF coil 108 may also have transmitter coil and receiver coil not shown in the figure. Separate and dedicated coils may be used for each of them, or a same single coil may be used for both transmitter coil and receiver coil.

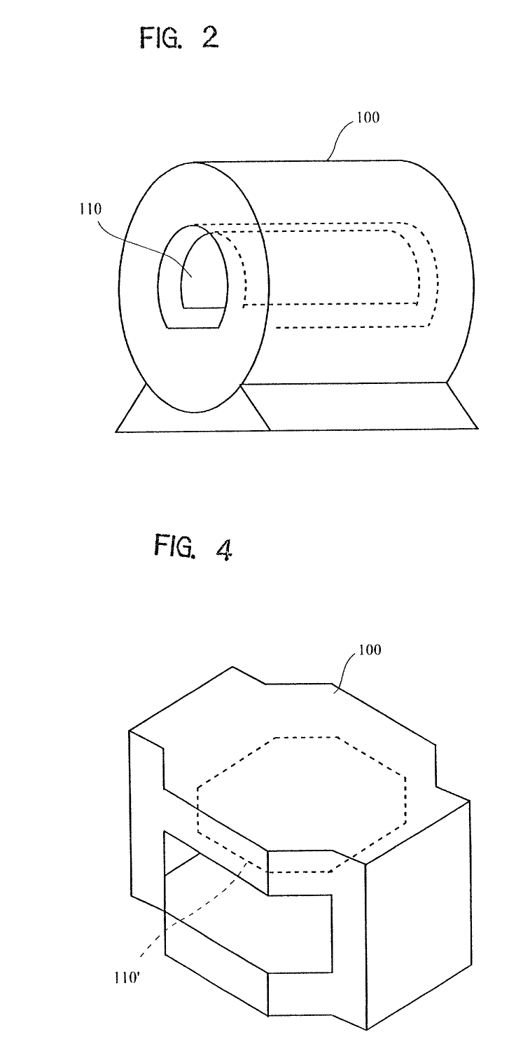

The magnet system 100 has a pressure sensor 110 in the bore, The pressure sensor 110 may be disposed everywhere on the wall surface toward the subject to be imaged 300 in the bore of the magnet system 100 as shown in FIG. 2, such that the subject to be imaged 300 may touch and press a pressure sensor 110 everywhere convenient for signaling the attendant waiting outside.

For the pressure sensor 110, an air-mat, having air sealed therein for examples may be used. When an air-mat is pressed the pressure inside will increase. It is to be noted here that the pressure sensor 110 is not limited to the air-mat, and may also be formed from a fluid-mat that conceals some water or oil and the like, in such fluid-mat, the inside pressure will increase by pressing it. The pressure sensor making use of pressure is preferable since there is no electromagnetic signals which may interfere the magnetic resonance signals upon operation. The pressure sensor 110 is an exemplary embodiment of a pressure sensing means in accordance with the present invention.

The output signals (pressure signals) from the pressure sensor 110 is input into a pressure detector unit 120. The pressure detector unit 120 will detect the presence and absence of the pressure applied on the pressure sensor 110, based on the output signals from the pressure sensor 110. The pressure detector unit 120 may be constructed by means of for example pressure-sensitive switches that generate contact signals, which nay be turned on when the input pressure is equal to or over a threshold level, and turned off when the input pressure becomes below a threshold level.

Alternatively the output signals thaw is turned on state may be held and turning off may be performed by a predetermined resetting operation. This mode may be preferable in that the subject to be imaged 300 needs not to continue to press the pressure sensor 110.

The output signals from the pressure detector unit 120 will be input to the alerter unit 122. The alerter unit 122 may be formed of a indicator light or acoustic speaker or both to indicate or warn by lighting the indicator light or by sounding the acoustic speaker or by doing both when the pressure sensor 110 is pressed, The alerter unit 122 may be an exemplary preferred embodiment of the indicator means in accordance with the present invention.

The gradient coil 106 is connected to a gradient driver unit 130. The gradient driver unit 130 applies driving signals to the gradient coil 106 to cause the coil to generate gradient magnetic field in the coil. The gradient driver unit 130 has three channels of driving circuitry, although not shown in the figure, each corresponding to three channels of gradient coils in the gradient coil 106.

The RF coil 108 is connected to an RF driver unit 140. The RF driver unit 140 applies driving signals to the RF coil 108 to transmit RF exciter signals to cause spins to be excited in the body of the subject to be imaged 300.

The RF soil 108 is also connected to a data capture unit 150. The data capture unit 150 gathers the receiver signals received by the RF coil 108 to store as digital data.

A controller unit 160 is connected to the gradient driver unit 130, the RF driver unit 140, and the data capture unit 150. The controller unit 160 may control the gradient driver unit 130 as well as the data capture unit 150 to execute the imaging process.

The output of the data capture unit 150 is connected to a data processor unit 170. The data processor unit 170 way be formed of for example a computer system. The data processor unit 170 also has memory that is not shown in the figure.

The data processor unit 170 may store the data captured from the data capture unit 150 in the memory not shown in the figure. Data space will be created in the memory. The data space may form two dimension Fourier space. The data processor unit 170 will perform two dimensional invert Fourier transform of the data in the two dimension Fourier space to generate (reconstruct) an image about the subject to be imaged 300. The two dimension Fourier space may also be often referred to as k-space.

The data processor unit 170 is connected to the controller unit 160. The data processor unit 170 is in position superior to the controller unit 160 and controls it. The data processor unit 170 is connected to a display unit 180 and a console 190. The display unit 180 may display the reconstructed image output from the data processor unit 170 and various information on it. The console 190 is used by an operator to input various instruction commands and information into the data processor unit 170.

The part comprised of primary coil 102, the gradient coil 106, the RF coil 108, the gradient driver unit 130, the RF driver unit 140, the data capture unit 150, and the controlled unit 160 is an exemplary preferred embodiment of a signal capturing means in accordance with the present invention.

The part comprised of the primary coil 102, the gradient coil 106, the RF coil 108, the gradient driver unit 130, the RF driver unit 140, the data capture unit 150, the controller unit 160, the data processor unit 170, the display unit 180 and the console 190 is an exemplary embodiment of an imaging means in accordance with the present invention.

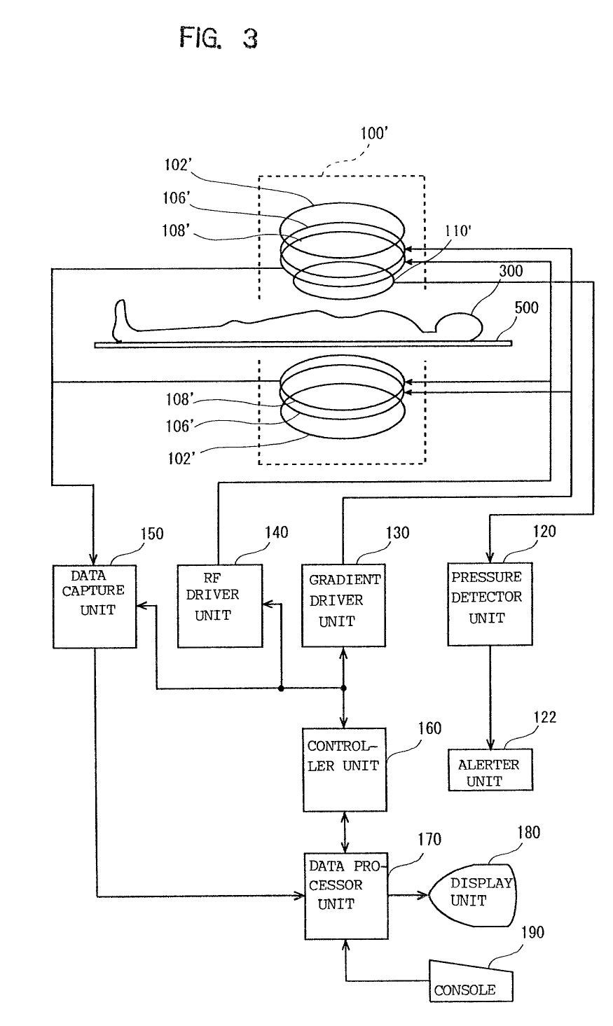

FIG. 3 shows a schematic block diagram of an MRI apparatus according to another type, This apparatus is also an exemplary embodiment of the present invention. The arrangement of this apparatus indicates an example of preferred embodiments with respect to the apparatus in accordance with the present invention.

The apparatus shown in FIG. 3 has a magnet system 100′ of the type different from the apparatus shown in FIG. 1. The apparatus has a similar arrangement to the apparatus of FIG. 1, except for the magnet system 100′, and the similar members are designated to the identical reference numbers and the detailed description of the parts already described in the preceding embodiment will be omitted.

The magnet system 100′ has a primary magnet 102′, a gradient coil 106′ and an RF coil 108′. Each of the primary magnet 102′ as well as other coils are, respectively formed of a pair of coils opposed to each other, which are disposed in the opposite sides of the bore space. These coils are all in the form of generic disk and are coaxially disposed. The subject to be imaged 300, laid down on the cradle 300, will be carried in and out of the bore broadly in the form of cylinder of the magnet system 100′, by means of a transporter mechanism not shown in the figure.

The primary magnet 102′ forms a static magnetic field in the bore of the magnet system 100′. The direction of static field is approximately perpendicular to the direction of body axis of the subject to be imaged 300. I.e., the primary magnet 102′ generates a so-called vertical field. The primary magnet 102′ may be formed for example from permanent magnets and the like. It should be appreciated by those skilled in the art that the primary magnet 102′ may also be constructed from a superconductor electromagnet or conventional electromagnet other than the permanent magnet.

The gradient coil 106′ may generate a gradient magnetic field for making a gradient in the static magnetic field intensity. The gradient magnetic field thus generated will be of three types including slice gradient field, read out gradient field, and phase encode gradient field, in correspondence with which three types of fields the gradient coil 106′ have three gradient coils, not shown in the figure.

The RF coil 108′ may transmit RF exciter signals into the static magnetic field for exciting spins in the body of the subject to be imaged 300. The RF coil 108′ may also receive magnetic resonance signals generated by thus excited spins. The RF coil 108′ has a transmitter coil and a receiver coil, both of which are not shown in the figure. A single same coil may be used for the transmitter coil and receiver coil, or separate and dedicated coils may be used for each of them.

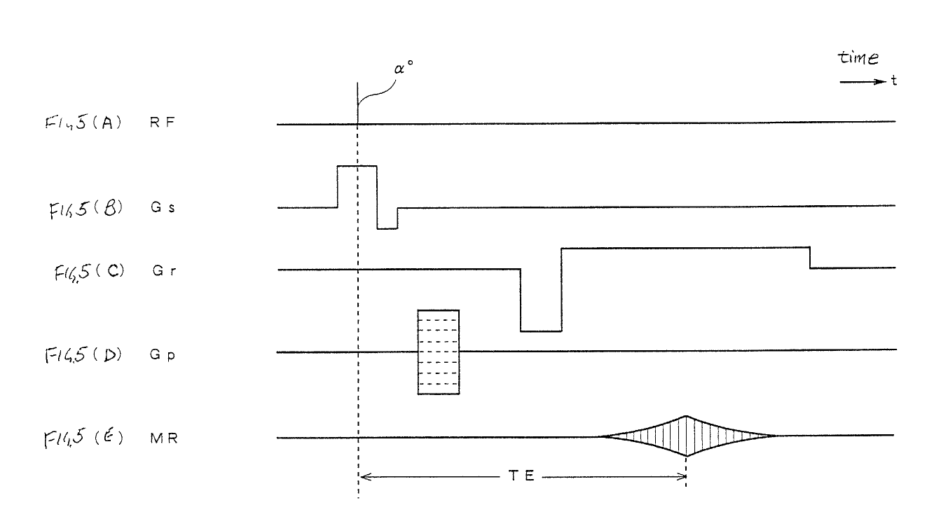

The magnet system 100′ has a pressure sensor 110′ in the bore. The pressure sensor 110 may be disposed everywhere on the wall surface toward the subject to be imaged 300 in the bore, as shown in FIG. 4, such that the subject to be imaged 300 may touch and press a pressure sensor 110′ anywhere convenient for signaling the attendant waiting outside.

For the pressure sensor 110′, an air-mat, having air sealed thereon for example, may be used. When an air-mat is pressed the pressure inside will increase. It is to be noted here that the pressure sensor 110′ is not limited to the air-mat, and may also be formed from a fluid-mat concealing some water or oil and the like. In such fluid-mat the inside pressure will increase by pressing it. The pressure sensor making use of pressure is preferable since there is no electromagnetic signals which may interfere the magnetic resonance signals upon operation. The pressure sensor 110′ is an exemplary embodiment of a pressure sensing means in accordance with the present invention.

The part comprised of primary magnet 102′, the gradient coil 106′, the RF coil 108′, the gradient driver unit 130, the RF driver unit 140, the data capture unit 150, and the controller unit 160 is an exemplary preferred embodiment of a signal capturing means in accordance with the present invention.

The part comprised of the primary magnet 102′, the gradient coil 106′, the RF coil 108′, the gradient driver unit 130, the RF driver unit 140, the data capture unit 150, the controller unit 160, the data processor unit 170, the display unit 180 and the console 190 is an exemplary embodiment of an imaging means in accordance with the present invention.

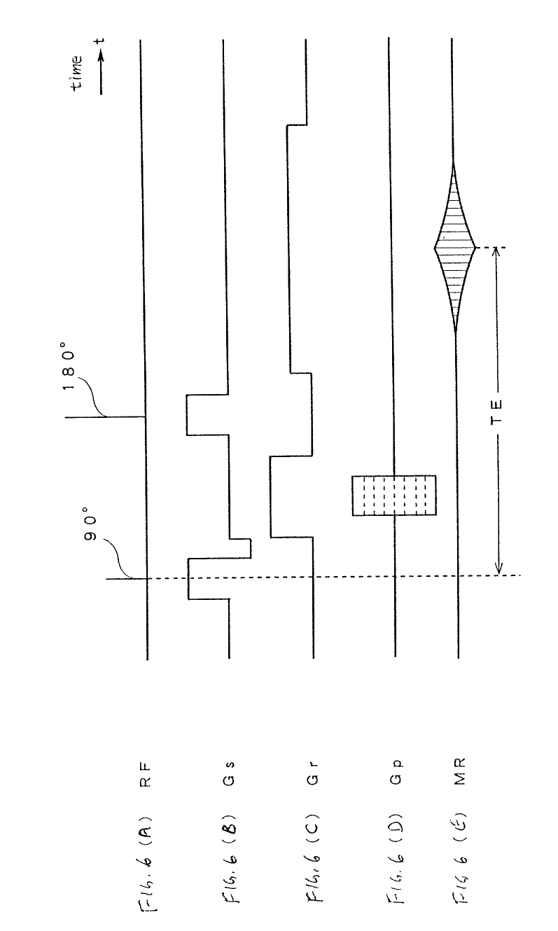

FIG. 5 shows an example of pulse sequences used for magnetic resonance imaging. The pulse sequences shown are those pulses according to the gradient echo (GRE) method.

More specifically, (1) is pulse sequences of α° pulses for RF excitation in the GRE method. Similarly (2), (3), (4) and (5) are sequences for slice gradient Gs, read out gradient Gr, phase encode gradient Gp, and gradient echo MR, respectively. The α° pulses may be represented by the central signal. The pulse sequences go from left to right along with the time axis, ‘t’.

As shown in the figure, α° pulses will excite spins at α°. The flip angle, α°, is less than 90°. The slice gradient Gs will be applied at this time so as to perform selective excitation with respect to a predetermined slice.

After α° excitation, the phase encode gradient Gp will phase encode the spins. Then the read out gradient Gr will dephase and rephase the spins to generate the gradient echo MR. The signal intensity of the gradient echo MR will be maximum at the point of time TE (echo time) after the α° excitation. The gradient echo MR will be recovered by the data capture unit 150 as view data.

Such a pulse sequence will be iteratively repeated for 64 to 512 times at cycle TR (repetition time). For each iteration phase encode gradient Gp will be altered so as to phase encode differently each time. The view data of 64 to 512 views fulfilling the k-space may be thereby obtained.

Another example of pulse sequence used for the magnetic resonance imaging is shown in FIG. 6. This sequence is a pulse sequence of the spin echo (SE) method.

More specifically, (1) shows sequence of 90° and 180° pulses for RF excitation in the SE method. Similarly (2), (3), (4), and (5) are sequences for slice gradient Gs, read out gradient Gr, phase encode gradient Gp, and gradient echo MR, respectively. The 90° pulses and 180° pulses may be represented by their respective central signal. The pulse sequences go from left to right along with the time axis, ‘t’.

As shown in the figure, 90° pulses will excite spins at 90°. At this time slice gradient Gs will be applied so as to selectively excite a predetermined slice. A predetermined period of time after the 90° excitation, 180° excitation by 180° pulses, in other words spin reverse will be performed. At this time also the slice gradient Gs will be similarly applied so as to selectively reverse the same slice.

During the period of time between the 90° excitation and the spin reversing, the read out gradient Gr and phase encode gradient Gp will be applied. The read out gradient Gr will dephase the spins. The phase encode gradient Gp will phase encode the spins.

After reversing the spins, the read out gradient Gr will rephase the spins to generate the spin echo MR. The signal intensity of the spin echo MR will be maximum at the point of time TE after the 90° excitation. The spin echo MR will be recovered by the data capture unit 150 as view data. Such a pulse sequence will be iteratively repeated for 64 to 512 times at cycle TR (repetition time). For each iteration phase encode gradient Gp will be altered so as to phase encode differently each time. The view data of 64 to 512 views fulfilling the k-space may be thereby obtained.

View data obtained from the pulse sequences of either FIG. 5 or FIG. 6 will be gathered into the memory of the data processor unit 170. The data processor unit 170 will two dimension inverse Fourier transform the view data of k-space to reconstruct the sliced image of the subject to be imaged 300. Thus reconstructed image will be stored in the memory and displayed on the display unit 190.

It is to be recognized by those skilled in the art that the pulse sequences used for imaging are not limited to those for GRE or SE method, but any other appropriate method including such as the fast spin echo method (FSE), fast recovery FSE method (FRFSE), time of flight method (TOF), and phase contrast method may be used instead.

In the process of imaging as have been described above, the subject to be imaged 300, who desires to signal to the operator or his/her attendant, may press anywhere convenient of the pressure sensor 110 (110′). Then, the pressure detector unit 120 will detest the increased pressure in the pressure sensor 110 (110′) to alert through the alerter unit 122. Therefore the signaling will be communicated to the person(s) staying outside.

The pressure sensor 110 (110′) is disposed everywhere in the inward surface of the bore of the magnet system 100 (100′), opposed toward the subject to be imaged 300. The subject to be imaged 300 may need not to have a signaling appliance as that commonly used in the prior art. Therefore, the subject may positively signal to someone staying outside, with no such risks that he/she does not have a means to signal after dropping the thing.

Although the present invention has been described with reference to an imaging apparatus that is an MRI apparatus by way of example for the purpose of illustration, the imaging apparatus may not be limited to the MRI apparatus. Rather any other imaging apparatuses including X-ray CT (computerized tomography), PET (positron emission tomography) and γ-camera may be equally used instead.

Many widely different embodiments of the invention may be configured without departing from the spirit and the scope of the present invention. It should be understood that the present invention is not limited to the specific embodiments described in the specification, except as defined in that appended claims.

1. A signal capture apparatus comprising:
a signal capturing device having a space for housing a signal capturing subject;
a pressure detector device disposed in said bore space for detecting the pressure by said signal capturing subject; and
an indication device for displaying output signal of said pressure detector device.

2. The signal capture apparatus of claim 1, wherein said pressure detector device is disposed on the entire wall surface opposing to said signal capturing subject.

3. The signal capture apparatus of claim 1, wherein said pressure detector device uses air pressure.

4. The signal capture apparatus of claim 1, wherein said indication device exhibits visual display.

5. The signal capture apparatus of claim 1, wherein said indication device exhibits audible presentation.

6. The signal capture apparatus of claim 1, wherein said signal capturing device uses magnetic resonance to capture signals.

7. An imaging apparatus comprising:
an imaging device having a space for housing a subject to be imaged;
a pressure detector device disposed in said space for detecting the pressure applied by said subject; and
an indication device for presenting output signals from said pressure detector device.

8. The imaging apparatus of claim 7, wherein said pressure detector device is disposed on the entire wall surface opposing to said subject to be imaged.

9. The imaging apparatus of claim 7, wherein said pressure detector device uses air pressure.

10. The imaging apparatus of claim 7, wherein said indication device exhibits visual display.

11. The imaging apparatus of claim 7, wherein said indication device exhibits audible presentation.

12. The imaging apparatus of claim 7, wherein said imaging device uses magnetic resonance for imaging.
